(19) United States
(12) Patent Application Publication
(10) Pub. No.: US 2013/0253969 A1
(43) Pub. Date: Sep. 26, 2013

(54) Broadcast Messaging of Incentives Based on Value

(71) Applicants: Rajarshi Das, Armonk, NY (US); Jason Benjamin Ellis, New York, NY (US); Robert George Farrell, Cornwall, NY (US); Wendy Anne Kellogg, Yorktown Heights, NY (US)

(72) Inventors: Rajarshi Das, Armonk, NY (US); Jason Benjamin Ellis, New York, NY (US); Robert George Farrell, Cornwall, NY (US); Wendy Anne Kellogg, Yorktown Heights, NY (US)

(73) Assignee: International Business Machines Corporation, Armonk, NY (US)

(21) Appl. No.: 13/424,964

(22) Filed: Mar. 20, 2012

(51) Int. Cl. G06Q 30/02; G06Q 10/06

(52) U.S. Cl. 705/7.13

(57) ABSTRACT

A method for a provider to generate incentives for users to perform tasks includes the following steps. The tasks are assigned to the users to obtain a matrix of task assignments in which each of the users is assigned to at least one of the tasks and each of the tasks is assigned to at least one of the users, wherein each of the task assignments has a value and a cost to the provider, wherein for a given one of the task assignments the value less the cost to the provider is an economic utility to the provider, and wherein the step of assigning the tasks to the users is done so as to maximize a net benefit to the provider which is a sum of the economic utility for all of the task assignments. Incentives are offered to the users to perform the task assignments.

### FIELD OF THE INVENTION

The present invention relates to data collection techniques, and more particularly, to improved mobile crowd sourcing techniques.

### BACKGROUND OF THE INVENTION

Information obtained from computerized sensors can be inaccurate for a number of reasons. First, the sensors may not take into account local conditions, such as temperature, weather, etc. Second, it is not always possible to place a computerized sensor at every relevant location, due for example to restricted access, etc. Third, computerized sensors may be expensive. Thus, there might be a limit on how many sensors can be deployed in a given area based solely on cost.

As an alternative, “human sensors” may be used wherein users/participants are used to gather data. However, gathering data this way can be expensive because it takes time and human effort. Furthermore, users may simply choose not to participate because for example they are too busy, prefer not to do the sensing, must travel to the location to do the sensing or incur other costs, etc.

Therefore techniques that generate incentives for human sensors would be desirable.

### SUMMARY OF THE INVENTION

The present invention provides mobile crowd sourcing techniques. In one aspect of the invention, a method for a provider to generate incentives for users u to perform tasks t is provided. The method includes the following steps. The tasks t are assigned to the users u to obtain a matrix of task assignments A(u,t) in which each of the users u is assigned to at least one of the tasks t and each of the tasks t is assigned to at least one of the users u, wherein each of the task assignments in the matrix A(u,t) has a value to the provider and a cost to the provider, wherein for a given one of the task assignments in the matrix A(u,t) the value to the provider less the cost to the provider is an economic utility to the provider, and wherein the step of assigning the tasks to the users is done so as to maximize a net benefit to the provider which is a sum of the economic utility to the provider for all of the task assignments in the matrix A(u,t). Incentives are offered to the users u to perform the task assignments.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary methodology for broadcasting incentives according to an embodiment of the present invention;

FIG. 2 is a diagram illustrating an exemplary methodology for computing the economic utility of users performing tasks according to an embodiment of the present invention;

FIG. 3 is a diagram illustrating an exemplary methodology for handling signals indicating task completion according to an embodiment of the present invention;

FIG. 4 is a diagram illustrating an exemplary communications system according to an embodiment of the present invention;

FIG. 5 is a diagram illustrating an exemplary apparatus for implementing one or more of the methodologies presented herein according to an embodiment of the present invention;

FIG. 6A is an exemplary table for matrix D(t) according to an embodiment of the present invention;

FIG. 6B is an exemplary table for matrix A(u, t) according to an embodiment of the present invention; and

FIG. 6C is an exemplary table for matrix P(u, t) according to an embodiment of the present invention.

### DETAILED DESCRIPTION OF PREFERRED EMBODIMENTS

As highlighted above, some potential drawbacks to using ‘human sensors’ to gather data are the mistakes that users can make gathering/reporting the data. Also, users may simply choose to ‘opt out’ of performing the task. To address these problems, one may offer incentives to the human sensors to participate and to do the job well and quickly. The present techniques are described in the context of mobile crowd sourcing which, for example, involves a provider (of tasks) sending short text messages (SMS) to users' mobile phones asking the users to do the tasks (e.g., collect data, answer questions, take certain actions, etc.). For example, the task might involve having a user(s) go to a location within a certain timeframe, collect some data at the location and then send the results back to the provider. As will be described in detail below, the present techniques are generally applicable to any sort of task, not just data collection.

In this case, the incentives given to the users could be in the form of money into a bank account, monetary prize winnings sent through e-mail, etc. In general, any (electronic) method of incenting the human sensors (users) for participating and doing well is possible as long as the incentive is variable (e.g., one can give more or less money). Non-monetary incentives such as badges, mobile phone minutes, reward points, and so on can also be used. In both cases (monetary and non-monetary incentives), each incentive can be quantified in terms of a monetary value.

A specialization of the present techniques is when the incentive is given or collected over a wireless network using a mobile phone. For example, incentives may be communicated using text messaging (SMS). For example, points, badges, or other non-fungibles may be granted based on participation. Another exemplary incentive scheme is to have a central location where people can go to collect mobile phone cards that they win (i.e., by performing their assigned task(s)). They can accumulate to some value, for example, $5 and then earn a card. The user must present the mobile phone with the proper telephone number and/or an assigned user identifier to the authority who then disburses the mobile phone card. Another exemplary incentive scheme is to issue a gift card number that users can use online. Typically in a sensing situation, some data is more important to gather than others. That is, each bit of data to be gathered has a value. This can be mapped to a monetary value. For example, one might need to collect more information about a disease as a function of the distance from the center of the outbreak and thus one might pay more for the data collected near the center. As another example, one might pay more for blood from ‘universal donors’ than other types of blood donors. Building on the incentives principle, the present techniques focus on providing more incentives or rewards to people who can collect the data that is most needed. Namely, a price/value is placed on the data since some completed tasks are worth more than others to the provider. Accordingly, a determination can then be made as to whether it is worthwhile to have someone go and collect the data. Note that the expense of sensing, such as travel cost, needs to be estimated based on known values (the cost of gas, the location of the user relative to the point of sensing, etc.). The individual human sensor will have to judge for him/herself if he/she is willing to accept the sensing task and incur his/her own costs.

The sensing may have to be performed as quickly as possible. In this case, the cost/benefit/incentive data can be precomputed and then messages can be sent to potential human sensors in parallel. As an optional step after receiving the data from the human sensor, the data can be evaluated. For example, is the data provided complete? of high quality? is it on time? is it consistent with other data being reported?

Paying people for microwork is known. For example, Amazon mechanical Turk can use people on the Internet to perform various tasks, some of which may be sensing tasks. It might, for example, have people look for something in an image and give a micropayment based on the result. Work is not done over mobile phones (it is done using a computer) so the issue of travel, weather, etc. does not come up. Also, it does not take into account the service's cost of having the workforce do various tasks—the assumption is that it is extremely low because this is done using Amazon servers and over the Internet.

As another example, TXTEagle enables people to do little bits of work over a mobile phone. See, for example, Nathan Eagle, “txteagle: mobile crowdsourcing” In Internationalization, Design and Global Development, Volume 5623 of Lecture Notes in computer Science (2009), the contents of which are incorporated by reference herein. However, TXTEagle does not use an economic utility model to determine an incentive based on cost vs. benefit. Instead TXTEagle uses a statistical model to estimate the correctness of answers and pays out based on user performance.

The present techniques address the issue of how to assign users tasks with an incentive structure that takes into account the user's costs and the value to the provider for users completing their assigned tasks. The following definitions are needed to understand the description that follows. The term ‘provider,’ as used herein refers to an entity (e.g., a service provider) with tasks to accomplish, such as data collection tasks, and the term ‘user,’ as used herein refers to an entity able to attempt tasks, such as people with mobile phones. Users may be identified in various ways, such as by mobile phone number or by an assigned user identifier (for example, a serial number, a PIN number, a code, etc.). When the user completes a set of tasks there is a benefit (e.g., an economic value) to the provider (the provider benefit). In some cases, the provider may incur costs to distribute tasks, collect data, and so on (the provider cost), see also below. The provider benefit minus the provider cost is the economic utility to the provider (provider utility). The incentive for a given user to perform a set of tasks is the money, mobile phone minutes, or any other kind of reward given by the provider to incentivize the user to perform the tasks. The sum of the individual incentives is the provided incentive. There is a budget for the provided incentive. A provider may have a limited budget. Any cost to the provider for advertising, contacting users, and so on is subtracted from the budget and the remainder is available as the budget for incentives. A user cost is the cost incurred by the user in performing his/her assigned tasks. The sum of the individual costs to the users is the users' costs. The present methodology first tries to cover all the users' costs. In some cases the total budget is more than sufficient for individual incentives to cover all users' costs. In this case, the provider cost will equal the users' costs and there is a surplus, defined as the portion of the budget remaining after subtracting provider cost from the budget. The surplus is then distributed so that each user receives as an individual incentive an equal percentage of the surplus. The sum of the individual incentives is equal to the provided incentive. In other cases, the total budget is not sufficient to cover all users' costs. In this case, the budget is distributed so that an equal percentage of each users' costs is covered. In this case, the provided incentive is equal to the budget.

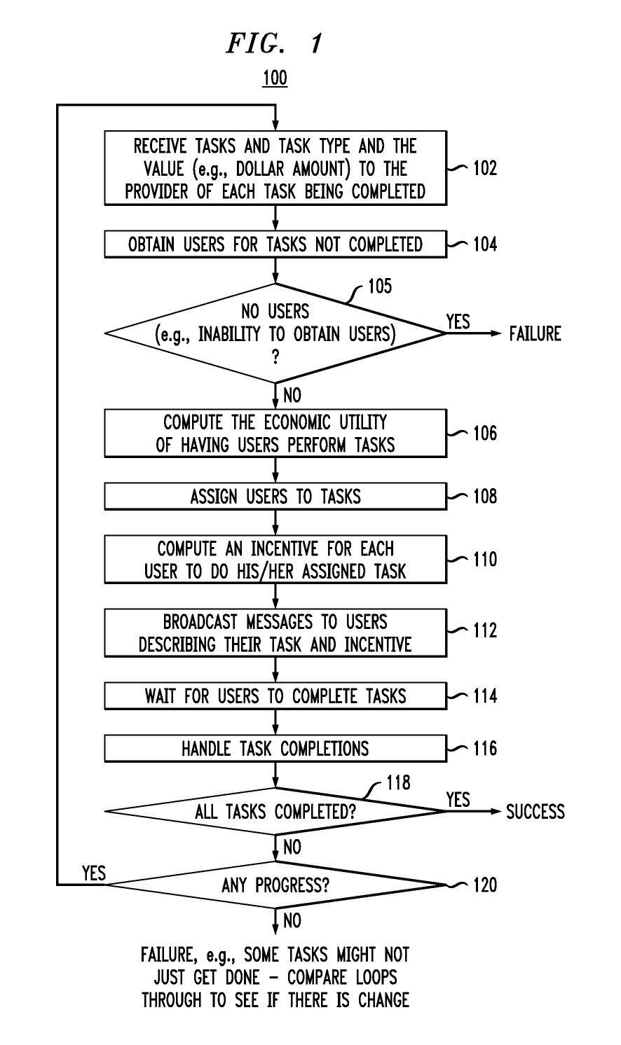

Given the above definitions a description of methodology 100 is now provided. FIG. 1 is a diagram illustrating an exemplary methodology 100 (performed, for example, by a provider) for assigning tasks to users, generating incentives for the users to perform the tasks based on the value of the tasks to the provider and broadcasting the incentives. An overall goal of methodology 100, given a set of tasks and a set of users with mobile phones (or other mobile devices such as laptop computers), is to 1) assign the tasks to the users so as to maximize a provider utility value for all of the users across all of the tasks (in other words, the tasks are assigned to the users so as to maximize a net benefit to the provider which is a sum of the provider utility for all of the task assignments), 2) offer the users an incentive that is a function of a benefit (value), if any, to the provider and a cost, if any, to the provider (as will be described in detail below, certain tasks may have an unknown benefit (value) to the provider and/or result in no costs to the provider—such as is the case when the users do not incur a cost to perform the tasks) and then 3) reward the users upon completion of the assigned tasks. If not all tasks are completed on time and with sufficient quality, tasks will be repeated and potentially assigned to other users.

Economic utility is a measure of benefit (value) considering cost (expenses). In particular, as will be described in detail below, in one exemplary embodiment, the present techniques use the economic utility to the provider of a user performing a task to compute the incentive. The economic utility to the provider is based on both a benefit (value), if any, to the provider of the user completing the task and a cost, if any, to the provider of having the user perform the task, for example, the cost of covering the users' costs (if any) to perform their assigned tasks. When looking to make task assignments, according to the present techniques, it is helpful to introduce the concept of expected value. Namely, since the tasks have not yet been performed, one has to consider the likelihood with which a user will perform an assigned task(s). According to an exemplary embodiment, an expected value to the provider is related to a probability that the user will perform the task (and with a certain level of performance) and the value to the provider of the user performing the task (in monetary terms) in other words, the likely monetary value. By saying the user ‘performs the task’ it is meant that the user will at the very least attempt to do the task even if the task is done with a less than ideal performance level. The actual cost to the provider, after the task has been completed, is based on the reward payout. The reward payout for a user completing a task is based on the incentive and can also be based on the actual cost of the user to do the task and the performance of the user on the task (timeliness, quality, and other factors can be considered), both measured after the task is complete. In one exemplary embodiment, the present techniques use the costs of the user (if any) in performing the task to determine the incentive. Once the costs of the user are addressed, any remaining budget for incentives is distributed equally amongst the users.

In step 102, a plurality of tasks T is obtained, as is the value to the provider for each of the tasks to be completed (value to the provider less cost(s) to the provider is a measure of economic utility to the provider (or simply provider utility), see description of step 104, below). Some exemplary tasks (e.g., finding standing water, donating blood, etc.) are provided below. Thus, the tasks associated with a given scenario are application specific. While several examples are given below, the present techniques are broadly applicable to any situation where the provider desires that some type of action be performed and where there is a value to the provider to have each of the tasks performed. The method keeps track of which tasks have been completed. If D(t)=0 then the task t has not been completed at a sufficient level of performance (on time and to a sufficient level of completion and quality). If D(t)=1, on the other hand, then the task has been completed and no further action will be taken to incent users to perform the task t. In step 102, D(t) is initialized to 0 for all tasks t in T.

The set of tasks T may be obtained from one or more providers. For instance, a blood bank may be looking for blood donations. Tasks may be pooled at an intermediary provider who aggregates tasks from multiple providers. A third-party intermediary may serve as a point of aggregation for all of these tasks. According to an exemplary embodiment, the steps of methodology 100 are performed by a single provider. Providers and intermediary providers may use a variety of methods to define and select sets of tasks. For example, the Red Cross might define tasks for collecting blood. Some tasks may include variables. For example, the blood bank may define a single task to collect a variable number of pints of a certain type of blood. Thus, the exact value of the variables may be determined after step 102, such as when users are assigned to tasks or after the tasks are performed.

In step 104, a set of one or more users U is obtained. It is assumed here that the set of tasks T have already been defined by the provider. The set of users U are then recruited or otherwise obtained.

A master list of users (and the method works with a subset of that master list) is first obtained, for example, from government, non-profit, corporate, telecommunications carrier, or other registry. Users may be further selected from the master list based upon their proximity to the tasks, their typical times of availability, their skill relative to the needs of the task, or other factors. Users may be recruited by means of e-mail, text messaging, phone, applications on a smartphone, and so on. An initial message may be sent to a large set of users from the master list and those who respond are then queried to provide additional application-specific information. This information may be stored in a database to be used again when additional tasks become available. These processes are known to those of skill in the art and thus are not described further herein.

A value to the provider for having user u successfully complete task t, i.e., V(u, t) is obtained, e.g., from the provider. V is a matrix of values, e.g., monetary values. Thus there are two different meanings of ‘value.’ A value to the provider' is an economic value. The ‘matrix of values’ is the ‘matrix of items’ and each item is an economic value. It is often the case that the value of the task being completed is independent of the user. In this case, the value will be the same for all users. For example, if there are two users, U1 and U2, and one task T1, V(1, 1) and V(2, 1) would be identical. The value to the provider for user u to do task t is dependent on the particular application at hand. For example, the value of getting one pint of a certain blood type may be $100 to a blood bank provider. The value of a rarer blood type may be $500. The value may, however, also depend on the individual doing the task (i.e., the value is not independent of the user). For example, the value of having an inexperienced donor may be only 50% of the value of having an experienced donor. This might be because an experienced donor may already have been screened for blood-borne diseases, less likely to faint, and so on. To use this method, the provider must assign an approximate value, usually monetary, to the completion of each of the tasks. Using the above example, V(1,1) is 0.50×100=50, V(1,2) is 0.5×500=250. Success is also relative. For instance, in step 322 of methodology 300 (see description of FIG. 3, below) there is a k level of completion, e.g., 50% completed, an o level of timeliness (e.g., 75% timely), and a q level of quality, e.g., 25% quality.

In step 105, a determination is made as to whether there are users available to which the tasks can be assigned. If there are no users available (i.e., there is an inability to obtain users), then a failure is the result. On the other hand, if users are available, then the process proceeds. The ‘availability’ of users may mean that there are no users suitable to complete the tasks at hand. For instance, there might be potential users available, but they might be too far away for the particular tasks at hand. Thus, a failure status is the result.

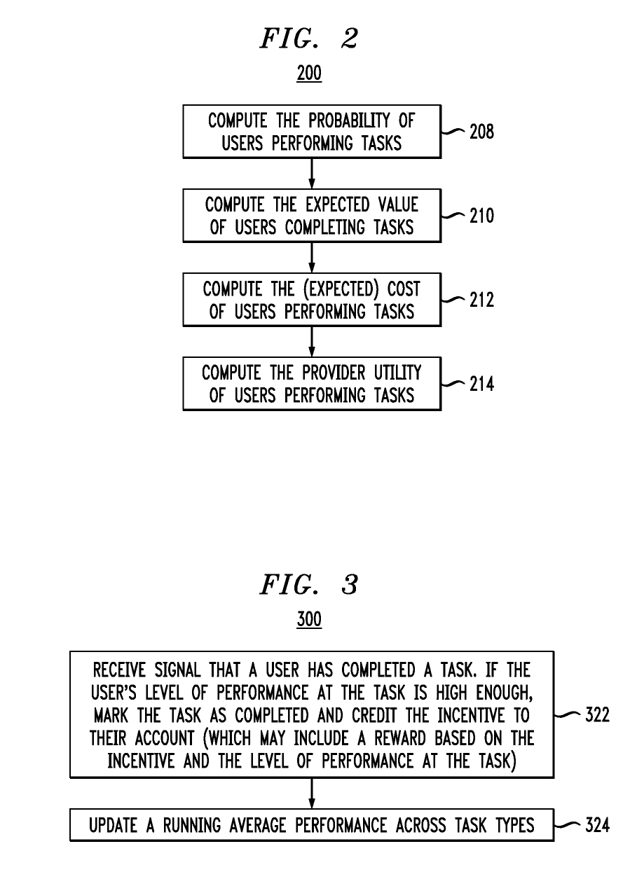

As provided above, a goal of methodology 100 is to assign the tasks to the users so as to maximize the provider utility for all users across all of the tasks (i.e., so as to maximize a net benefit to the provider). Thus, in order to compute an assignment of users to tasks (see description of step 108, below) the system needs to determine the provider utility (economic utility to the provider) of each user with respect to each task (step 106). Matrices are used to compute all of the alternatives. That is, the provider utility of user 1 completing task 1 to a sufficient level of quality must be considered as well as the provider utility of user 1 completing task 2 to a sufficient level of quality, since user 1 has yet to be assigned to either task 1 or task 2. This is true of user 1, user 2, and indeed all of the users. Thus, in step 106, a provider utility matrix U(u, t) is computed based on the provider utility of each user with respect to each task. This provider utility matrix is then used to determine the assignment of individual users to individual tasks. Step 106 may be performed using the process outlined in FIG. 2 (described below).

As highlighted above, one goal of methodology 100 is to assign the tasks to the users so as to maximize an economic utility value for the provider (provider utility) across all of the users and across all of the tasks (i.e., so as to maximize a net benefit to the provider). Having a user close by perform a task makes more sense than having one farther away, for example, as that can serve to minimize the costs involved. Similarly, having a user who is skilled at a given task t do that task makes more sense than having someone unskilled, for example, since that increases the expected value by increasing the probability that the user will complete the task (see above). For instance, if the task is collecting data related to a meteorological event then the data collected by a user in the field of atmospheric sciences might be more valuable than data collected by a less skilled user.

Depending on the particular tasks at hand for the given application, some additional constraints may be implemented in order to help maximize the economic utility to the provider (provider utility). By way of example only spatial, temporal or spatio-temporal constraints may be imposed. Spatial, temporal, and spatio-temporal constraints can serve to both constrain the users and/or tasks with the goal of saving expenses, targeting high value tasks, and so on and to provide incentives to users with a high probability of completing tasks and with a sufficiently high level of performance. According to an exemplary embodiment, the tasks may be given spatial constraints such that user(s) performing the task(s) must be within a given distance from where the tasks are located. It is also possible that the user(s) must be at a particular location or locations or, for example, must be travelling along a particular path when doing the task. For instance, when collecting data about a certain location, it makes sense that the users must be at that location when performing the task.

With regard to temporal constraints, it may be required that the user perform the task at a particular point in time, or within a certain time frame. For instance, if the task involves collecting data on a certain meteorological event, it makes sense that the user must collect the data while the event is occurring.

Also, say for instance, the task is collecting temperature data for a particular region during the month of September. Then of course the time period for performing the task is during the month of September. This example also highlights a spatio-temporal constraint, e.g., the user must perform the task at a location or locations or travel along a particular path at a particular time or within a range of times. So in this case, the user must report temperature data at a certain location during the month of September.

These spatial and/or temporal constraints may be incorporated into the process as follows. As described above, P(u, t), the probability user u completes task t (which factors into the expected value) can be based on the user's level of skill, the user's past history regarding the task at hand, etc. In this case, P(u, t), can also be a function of distance, time, and other factors as described above. The probability becomes zero for a user to perform the task at certain locations, times, etc. Thus, using a simple example, if a particular user is not present at a particular location or is unavailable at a time where/when data needs to be collected, then the P(u, t) for that user for the given task is zero. When this is the case, then no cost is incurred, so the expected value is zero. On the other hand, if the user does meet the spatial and/or temporal requirements for the task at hand, the other factors related to P(u, t) (e.g., user skill, past history, etc.) also need to be considered, as described above.

The set of users and/or tasks may also change over time. For example, the set of mobile users might change during the execution of a task, for example by some of the users changing mobile devices, new users opting in and/or other users opting out, an increase or decrease in the number of available users, etc. By way of example only, users may be identified based on the particular mobile device they use. As is common, a given user might employ multiple mobile devices, such as a smartphone, a laptop, etc. Thus, the set of users might constantly be changing as users switch from one mobile device to another.

These changes in users and/or tasks may be accommodated as follows. Steps 102 through 120 form a loop that may be repeated multiple times and results in either success (all tasks complete) or failure (no progress and some tasks incomplete). If users join or leave or tasks are added or dropped in steps 106 to 120, the changes can be queued and processed the next time through the loop. A queue of task changes can be kept indicating that a task has been added or dropped and a queue of user changes can be kept indicating that a user has joined or a user has left. The second and subsequent times through the loop, changes to tasks can be performed in step 102. Tasks are added and dropped in the order the changes were queued, by processing the task changes in order. Similarly, the second and subsequent times through the loop, changes to users can be performed in step 104. Users are added and dropped in the order the changes were queued.

In step 106, a fixed set of users and tasks having been determined, the provider utility U(u, t) is computed. U(u, t) is a matrix of users and tasks. The value of U(u, t) for any given user u and task t is the provider utility of having user u perform task t. This measure is based upon the expected value to the provider for having user u perform task t and the provider costs. The expected value is based upon a probability that user u completes task t. The probability that user u completes task t can be based on the user's level of skill, the user's past history regarding the task at hand, and other factors. According to an exemplary embodiment, the probability is based on the past history of all users regarding tasks of the same type as the task at hand. The probability may be zero for a user to perform the task at certain locations, times, etc. Thus, using a simple example, if a particular user is not present at a particular location or is unavailable at a time where/when a task needs to be performed, then the probability for that user for the given task is zero. When this is the case, then no cost is incurred, so the expected value is zero.

If the skill, history, etc. of a user changes during the loop, there will be an increased or decreased probability that a user u will complete a task t. For example, a given user might have a greater level of skill at performing task A than task B. Thus, a task change from A to B might reduce the probability. A change to the probability might also result if a task is changed from a less skilled user to a more skilled user. Further, since the cost is dependent on the particular user and task, then the expected value of user u completing task t may also change on subsequent times through the loop to reflect the increased or decreased cost. For instance, the user might have to travel farther to perform task B than to perform task A.

Thus changes to the probability and/or cost may affect the provider utility of having various users complete various tasks and accordingly, the overall provider utility U(u, t). In this case, the assignments may change.

If the value of U(u, t) is negative for any user assigned to a given task, the costs to the provider for the user to do the task outweigh the benefit (to the provider) of having the task performed (e.g., collecting the data). For instance, by comparing the expected value of user u performing task t with the cost of providing the minimum incentive to the user to perform the task, it can be determined whether or not the provider benefits exceed the costs. In most cases, based on this evaluation, it would not be beneficial to contact a user unless U(u, t)>0 because only then is it worthwhile. Again using the above blood donation scenario as an example, if the expected value for a given user u and task t is $50, and the cost of having the user u travel to the donation center is $10, then as per the cost benefit analysis it would be beneficial to contact the user. On the other hand, if for example, another user has a more abundant and/or less needed blood type and the expected value for that user is $10, then the cost benefit analysis might indicate that it is not beneficial to contact that particular user. The provider utility U(u, t) is computed for all user and task combinations.

As highlighted above, another goal of methodology 100 is to offer users an incentive as a function of the users' cost to perform their assigned tasks. Thus in step 110, the incentive for each user to do his/her assigned task, i.e., I(u, t), is computed. However, users may not perform a task if the incentive does not cover their costs. Costs may include their travel, airtime, etc. Accordingly, a cost matrix C(u, t) is computed. According to an exemplary embodiment, first, any tasks that are assigned (to users) with negative or zero overall provider utility U(u, t) are dropped and the users will not be contacted to perform the task (no message will be sent), i.e.,

if U(u,t)≦0 then set A(u,t)=0.

Incentives are distributed to users with task assignments based on any costs of the users to perform their assigned tasks and any available budget for incentives. If a budget for incentives (i.e., incentive budget b) is at least equal to the sum of the costs C(u, t) for the remaining tasks, then the remaining portion of the budget is surplus. The surplus is divided amongst the users. If divided equally, this results in an incentive of:

I(u,t)=C(u,t)+y,

where the cost-plus incentive, y, is set as follows:
y=b/n where n is the number of users u where A(u, t)=1.
   Thus, for tasks that are of positive overall utility U(u, t) from a provider's perspective, the incentive covers costs and provides an additional incentive that is distributed across the users who are assigned to tasks. These incentives could be used in the case where no additional incentives could compel a user to complete a task with higher performance, for example, when giving a blood donation. No additional incentive would make it possible for the user to perform this task. An alternative method may be used, for example, if an additional incentive might convince a user to complete a task faster or with higher quality. In this case, the incentive can be provided proportionally to the expected value of user u performing task t, E(u, t) as follows:

I(u,t)=C(u,t)+b*(E(u,t)/ΣE(u,t)).

E(u, t) is computed (in step 210 of methodology 200 (FIG. 2), described below) as part of step 106. In this case, the incentive covers the user's costs plus an additional incentive that is a portion of the budget. The expected value (benefit) of user u performing task t is used to determine what portion of the budget will be included in user u's incentive to do task t. Users are provided with additional incentive according to the value to the provider of the user completing the task. These incentives could be used when additional incentive might compel users to perform a task with higher performance. For example, when finding stagnant water, a user might stick with the task to completion or do the task better if more incentive was provided. An incentive can be offered to users even when the budget does not cover costs, since the users may still perform the task. This might be the case if the user receives some additional benefit, such as an intrinsic benefit. For example, the user might travel to give blood at a blood center even if the user's costs are not covered if they feel good about the donation. In this case, there is no surplus. The incentive budget b is distributed amongst the users so that any given user receives a portion of the budget according to the portion of the total costs incurred by all users that the individual user is incurring. Thus the total cost incurred by all users is:

L=ΣC(u,t) where A(u,t)=1

and the incentive matrix is thus:

I(u,t)=b*(C(u,t)/L) if A(u,t)=1

I(u,t)=0 if A(u,t)=0.

Thus, the incentive for u to do task t is a fraction of the budget determined by the portion of the total cost incurred by the user u when doing task t. Thus, given a budget of $3 to do two tasks, T1 and T2, if U1 is assigned to T1 and U2 is assigned to T2, then if U1 must spend $6 to do task T1 and U2 must spend $3, then U1's incentive will be $3*(6/9)=$2 and U2's incentive will be $3*(3/9)=$1. In this case, U1 will have to spend $6−$2=$4 out of pocket and U2 will have to spend $3−$1=$2 out of pocket. Costs are thus offset by the budget, but are not completely covered by the budget.

The incentives, I(u, t), will have the same number of rows and columns as C(u,t), but only where A(u, t)=1 will be used. So, if u1 is assigned to task t2, then A(u,t) will have u1 and t1=0, u1 and t2=1, and u1 and t3=0 and if u2 is assigned to t1 then u2, t1=1 and u2, t2=0 and u2, t3=0. In this way, an incentive I(u,t) will only be sent to a user u if that user is assigned to the task t in the matrix A(u, t).

Accordingly, in step 108 users are assigned to tasks. In this step, each of the users (from step 104) is assigned to at least one of the tasks (from step 102) and each of the tasks is assigned to at least one of the users. A task assignment matrix A(u, t) is computed such that the total provider utility across all tasks E U(u, t) is maximized. The dimensions of the assignment matrix are the number of users by the number of tasks. If a user u is assigned to a task t then A(u, t)=1, otherwise A(u, t)=0.

According to an exemplary embodiment, the Hungarian method is used to solve this assignment problem. See, for example, H.W. Kuhn, “The Hungarian Method for the Assignment Problem,” Naval Research Logistics Quarterly, vol. 2 (1955), pp. 83-97, the contents of which are incorporated by reference herein. As is known in the art, the Hungarian method is a combinatorial optimization technique which solves an assignment problem in polynomial time. The Hungarian method can be used to easily and effectively assign tasks to users so as to attain the best task assignments from a given set of users. As described above, the size of the assignment matrix would thus be the number of users multiplied by the number of tasks. Other methods for solving the assignment problem could be used such as simulated annealing (see, for example, Sahu et al., “Solving the Assignment Problem using Genetic Algorithm and Simulated Annealing,” IAENG International Journal of Applied Mathematics, 36:1 (Feb. 1, 2007), the contents of which are incorporated by reference herein) or the simplex method (see, for example, M.S. Hung, “Technical Note—A Polynomial Simplex Method for the Assignment Problem,” Operations Research May/June 1983, vol. 31, no. 3, pp. 595-600, the contents of which are incorporated by reference herein).

In practical implementations it should be considered that the overall resources for providing the incentives are not limitless. For instance, when the incentives include monetary values there might be a certain fixed amount allotted for total payments (the incentive budget, b, mentioned above). Thus, as tasks are completed and incentives are disbursed, the total amount is decreased. Alternatively, more incentives might be offered to users if tasks are not completed. Thus, the incentive may also be a function of the incentive budget. The budget may increase/decrease during execution of the task. Any additional budget may be used to offer additional incentives to mobile users who may easily become unavailable or become available (see above) to perform tasks that may change (see above). By way of example only, the amount to use for incentives might increase due to additional budget becoming available or might decrease if the budget is reduced during execution.

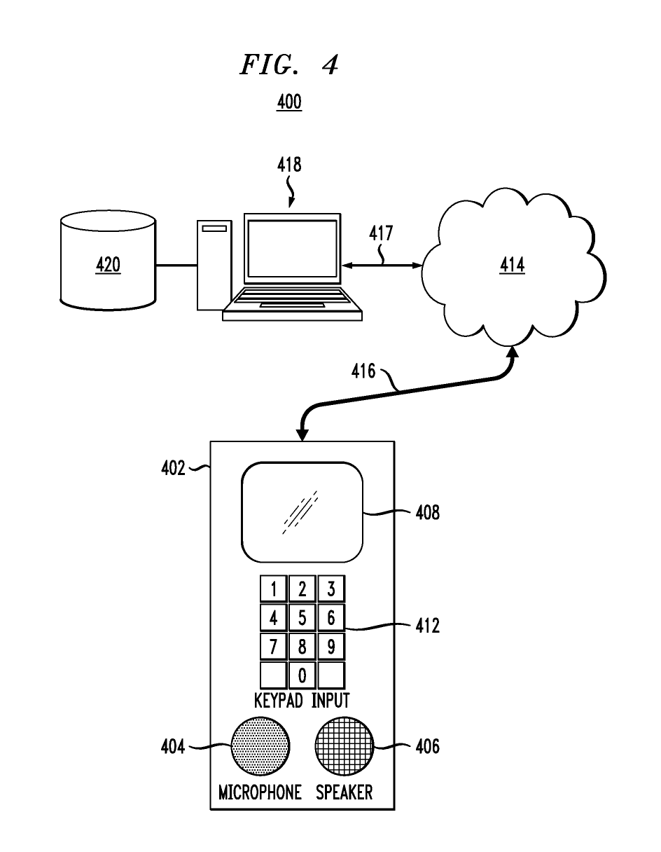

Given the assignments made in step 108, the incentives may be broadcast (see below) in a number of different ways. An exemplary system for enabling communications between the provider and users is provided in FIG. 4, described below.

In the method, based on the task assignments (step 108) and incentive calculations (step 110) in step 112, a message is broadcast to each assigned user, for example to each user's mobile device, (where there is a row for a given user with one or more tasks in A(u,t)=1) describing his/her task t and his/her incentive I(u, t) for completing the task. According to an exemplary embodiment, a message is broadcast with the task assigned to that specific user (find the user and get the task where A(u, t)=1 and the incentive being offered for performing the task I(u, t)). The message may further contain a deadline by which the user has to perform the task. Some exemplary criteria for determining the deadline are described in conjunction with the description of step 114, below.

Alternatively, the same message may be broadcast to all users that sets forth the tasks and incentives for each of the users (and potentially a deadline for completing each of the tasks). By broadcast, it is meant simply that all of the messages are sent within some temporal proximity. They may be sent sequentially or in parallel. In this embodiment, the method loops over the tasks and generates a text message to the user assigned to the task. Various mechanisms could be used to reach the individual user when they are available.

In step 114, the system waits for users to respond to the broadcasted tasks (each with an incentive) for an amount of time (a deadline) and then sees if all tasks have been completed (in step 118). The amount of time/deadline can be set based on the specific application. For example, it may be advantageous to wait no more than 24 days for blood donors. Alternatively, the amount of time offered may be dependent on the particular user and task. In one exemplary embodiment, the distance from the user to the task and the average walking speed is used to estimate the amount of time it will take a user to walk directly to the location of the task. Each task may also take a certain amount of time to complete. These are added together to get the amount of time for the user to walk to the task and complete the task and multiplied by a constant factor (for example, 2) to determine a deadline. The deadline may be communicated in the message broadcasted to users to inform them that they must complete the task by the deadline.

In step 116, users are handled one by one as they finish their tasks. Next, the assigned user is rewarded for completion of the assigned task by having the incentive or a portion thereof credited to his/her account. For example, the incentive may be cell phone minutes and the minutes may be credited to the user's account with his/her telecommunications provider. Step 116 may be performed using the process outlined in FIG. 3 (described below).

After completing the steps 102-116, there are three outcomes. First, all of the tasks could be completed. Second, some tasks could be completed but others remain, but progress is being made. Third, some tasks could be completed but others remain.

In step 118, after waiting a time equal to the longest task deadline, while handling task completions, the method checks if all tasks are marked as completed. If all tasks are completed, the method halts with success. If all the tasks are not completed, the method continues to step 120.

In step 120, progress on tasks is measured. There are various ways to accomplish this, but in the embodiment illustrated in FIG. 1, the completion status of tasks from performing steps 102 through 118 is compared with the completion status of the same tasks the next time through the loop (steps 102 to 118). The nth time through the loop, D(t) is compared with D₂(t), a copy of D(t) from the n-lth time through the loop. The first time through the loop, D(t) is compared with D₂(t) filled with zeroes (meaning that all tasks are incomplete). If these lists are identical, i.e., D(1)=D₂(1) and D(2)=D₂(2) etc. then there was no progress completing tasks on the last loop and the method halts with failure. If there is progress, then the system loops back to step 102. A variable, h, is set to 1 if this is the first time through the loop and 2 if this is the second time through the loop, and so on. The system uses h to determine if this is the first or a subsequent time through the loop. At this point, the system proceeds through the same loop 102 through 118. In step 102, one or more of the tasks may change and in step 104 one or more of the users may change, but otherwise it is the same set of steps through the loop. If the tasks change in step 102 or the users change in step 104, then the assignments, incentives, probabilities, expected values, costs, utilities, and so on, are reset. D(t) does not change unless the tasks change and S(y) is not reset and continues accumulating probability values for each of the task types.

FIG. 2 is a diagram illustrating an exemplary methodology 200 for computing the economic utility to the provider of users performing tasks (provider utility). As highlighted above, methodology 200 represents one exemplary way to carry out step 106 (of methodology 100). In step 208, a probability that user u will complete task t, i.e., P(u, t), is computed for all user and task combinations. P(u, t) could be based at least in part, on factors, such as the distance of the user to the task and skill of the user at the task. Note that this application-specific information can be acquired from users, retrieved from a database, or other means. This assumes that the user meets other potential requirements for performing the task, such as spatial and/or temporal requirements, as described in detail below. In one exemplary embodiment, a history of users' attempts at the type (kind) of task is used. For each task t in P(u, t), the type of task is determined then a running average percentage of users completing tasks of this type, w, in the past, S(w), is set into P(u, t) for all users. If D(t)=1.0, because the task was completed on a prior iteration, then P(u, t)=1.0 is then set for all users. The skills of the user or other factors could be used to adjust the probability values in P(u, t).

In step 210 of methodology 200, an expected value of u performing task t, i.e., E(u, t), is computed for all user and task combinations. The expected value E(u, t) is calculated as a function of V(u,t), the value to the provider for having user u successfully complete task t and the probability that the user will complete the task P(u, t) to a sufficient level of performance,

E(u,t)=P(u,t)×V(u,t).

Using the above example, if the value to the provider of getting one pint of a certain blood type is $100 from user u, and the probability that the user u will donate blood is 50% (based, for example, on that user's past history which indicates that when asked to donate blood the user does so about half of the time), then the expected value here is $50.00. Values are computed for all user and task combinations. Thus, E(1, 1)=P(1, 1)*V(1, 1) and E(1, 2)=P(1, 2)*V(1, 2) and E(2, 1)=P(2, 1)*V(2, 1) and E(2, 2)=P(2, 2)*V(2, 2).

As highlighted above, in addition to the value to the provider for users completing their assigned tasks, the present techniques also take into account the cost to the users for performing the tasks. For instance, when the task involves the user collecting data or donating blood, there may be costs (to the user) associated with performing the tasks—for example, the user might have to drive there, e.g., to collect the data, donate blood, etc. and this could cost in gas, wear on the vehicle, etc. It also might cost some money per hour (i.e., a fee) for the person to do the work. Thus, in step 212, the cost of each user to do each task, i.e., C(u, t), is computed.

In the example provided the cost is the same for each user, but there may be economies of scale that allow the costs to go down as there are more users. For example, a single truck might be able to hold 6 users going out to do sensing, but that same cost would have to be incurred for one user also. Each mobile device may be able to report its location (via GPS, multilateration, or other methods). This information can then be used to calculate costs, etc. According to an exemplary embodiment, C(u, t) is calculated by determining the distance between the user u and the task t (e.g., location for which data collection is needed, blood donation center, etc.) and calculating based upon a fixed cost per distance f.

In step 214, the utility of user u doing task t, U(u, t), is computed for all user and task combinations. This computation is based on the values computed in step 210 (E(u, t)) and step 212 (C(u, t)). Specifically,

U(u,t)=E(u,t)−C(u,t).

Values are computed for all user and task combinations: U(1, 1)=E(1, 1)−C(1, 1) and U(1, 2)=E(1, 2)−C(1, 2) and so on. Using the same blood donation example from above, if the expected value for the donor/user is $50 and the cost of having the user travel to the donation center is $10, then the overall utility to the provider for the task is $40.

FIG. 3 is a diagram illustrating exemplary methodology 300 for handling signals indicating task completion. As highlighted above, methodology 300 represents one exemplary way to carry out step 116 (of methodology 100). In step 322, given a signal that the user u completed task t the method uses an application-specific technique to determine p, the user's level of performance at the task. In an exemplary embodiment, p is based on k, the level of completion, and the quality q, namely p=k×q. The performance across all users and tasks is stored in Q(u, t). Thus, Q(u, t) is filled gradually as users complete their tasks. When the first user completes the first task, Q(1, 1) will be filled with a value between 0.0 and 1.0. An incentive p×I(u, t) then is credited to the user's account, namely, the account of the user assigned in A(u, t). According to an exemplary embodiment, the level of completion is based on how well the user completed the task (e.g., whether the data the user collected is accurate), q, and how much of the task the user completed (e.g., the user may complete some part less than the whole task), k. For example, if a user was supposed to provide blood, they might provide up to a pint, but a half pint is also acceptable. After determining this amount, the blood quality might be assessed on a scale and of the half pint only ¼ of a pint might be acceptable. Thus, the overall level of performance would be ¼. Q(u, t) would be set to 0.25 according to the user u who finished task t. In the embodiment, the signal for doing 322 comes from the user sending a text message. Other possibilities are requesting the award, a provider survey, or other means. In the method, users send a text message to the provider indicating that they are done with an assigned task.

In step 324, according to an exemplary embodiment, statistics are updated, including the average performance of all users on tasks of the same type as the current task. For each task y, S(y) holds the average performance of all users who completed task, y. H(y) holds the number of times tasks of type y have been attempted and signaled as complete. For example, blood donations at clinics may be of two types: ‘standard blood donation’ and “donation from a universal donor.” The task types are specified initially along with the tasks at step 100. S(y) and H(y) are then updated. H(y)_=H(y)+1. S(y)=(S(y)+p)/H(y)) where p is the level of performance reported by the user signaling completion. For example, if in this case, a user completed a universal donation at a 0.5 level of performance and the previous average level of performance for universal donations was 0.10 averaged across 2 users. Thus H(y)=2+1=3 and S(y)=(0.10+0.5)/3=0.3. D(t) is the completion status of task t. In this embodiment, 0.9 is used as the threshold. This threshold could be exceeded if, for example, the task was (0.9) complete and of highest quality (1.0) or if the task was fully complete (1.0) and of high quality (0.9). This threshold prevents a task being assigned again and again to different users in an attempt to get a perfect (1.0) level of performance. It is possible for the contributions of many users to influence D(y). Thus, the value of Q(u,t) would be summed across all users for a given task. For example, one user might complete half of the task and other user(s) complete the other half. The sum of the two performance values would thus exceed the threshold. Another option is that separate thresholds are applied to each of k, q, and so on. It is also possible that multiple users end up completing the same task, perhaps because the tasks were assigned redundantly in the first place.

Another option is that tasks are evaluated by the provider or by the receiver of the task, as ratings, for example. In this case, the award may be given proportionally to the quality of the result. For example, if a user is asked to find the location of large bodies of standing water, the quality might be determined as a percentage of the total area of the affected region.

By way of example only, one could require submission of proof that the sensing was done (e.g., photographs, documentation, etc.). This can be done using a mobile phone with a camera that transmits the picture via MMS messaging. This embodiment is using mobile phones and SMS messages, but other means of communication and messaging could be used. Also, the data that results from the action, if any, can be transmitted in any way. It could be over SMS, as in the embodiment, but it could also be over other transports, such as e-mail, as long as the user has access to a device while at the required time and location that can connect over a network to the computer where the central processing for the service is done. For example, a smart phone over GPRS could be used.

In practice, completion, quality, timeliness, and other factors need to be evaluated in an application-specific way. Thus, the results of tasks might be collected and sent to judges or automatically judged. In the blood donation example, the blood may have to be sent to a lab to judge its quality. The result of this task would have to be manually judged. The lab technician determines a level of quality based on lab analysis. In the standing water example, the size and water quality would be automatically judged. In this example, the users take pictures on their mobile phones and transmit the pictures. The location and time of transmission are recorded. Once a time limit is reached, any tasks without pictures are marked as a timeliness of zero and thus not complete. The location where the picture was taken is compared with the stored location of all the tasks (the center of the region) and any pictures too far from the location are judged as being not complete. Stagnant water eventually changes color, so the color of each photograph can be used to judge its quality. Photographs that are not of high enough quality are judged as not complete. Thus, photographs close to the proper region, within the time limit, and judged to be the color of stagnant water are collected. Using this data, a map of stagnant water locations with photographs can be obtained. Incentives are required in this case, because traveling to a mosquito-ridden and/or swampy area is not desirable, travel to such regions is often on foot, and pictures need to be taken during the day (conflicting with working hours).

FIG. 4 is a diagram illustrating an exemplary communications system 400 that permits the provider to broadcast messages regarding tasks and incentives to the users and receive data back from the users. System 400 includes one or more user mobile devices 402. Mobile devices 402 may be any type of mobile computing device capable of sending/receiving SMS messages. In some exemplary embodiments, mobile devices 402 contain a camera (not shown) which enables the users to take pictures and send those pictures, via network 400, to the provider. Similarly, in this case, the provider could also send images to the users which the users can view on their mobile devices 402. Such a capability might be useful in instances, for example, when the provider wants to indicate a specific location to the users, e.g., by providing an image of a map with a star indicating specifically from where the users should collect data.

In one embodiment, mobile device 402 includes a microphone 404 and a speaker 406. Mobile device 402 may be a cellular or “smart” phone, a PDA or other hand held communications (computing) device or a landline telephone that includes a microphone 404 and a speaker 406. For completeness, other components of mobile device 402 may include a display screen 408 and an input key pad 412. It shall be understood that some of the components of client computing device 402 may be combined together. Client computing device 402 may include the ability to connect to a telecommunications voice network, capture audio and/or broadcast audio.

Mobile devices 402 may be coupled to a communications network 414 (operated by the, e.g., phone's carrier). Communications network 414 may be a cellular network in one embodiment. For example, communications network 414 could be a GSM, TDMA, 2G, 3G or 4G wireless network. Communications network 414 could also be a wireline telecommunications network offering telephone service (Plain Old Telephone Service or POTS). Communications link 416 represents hardware connecting client computing device 402 (i.e., the phone) to the telecommunication carrier's network. Of course, communications link 416 could be wireless or physical. In one exemplary embodiment, communications network 414 includes a connection to an intranet or the Internet. The voice on the telecommunications voice network could be carried over the Internet Protocol (IP) as is commonly done in VoIP (Voice-over-Internet-Protocol).

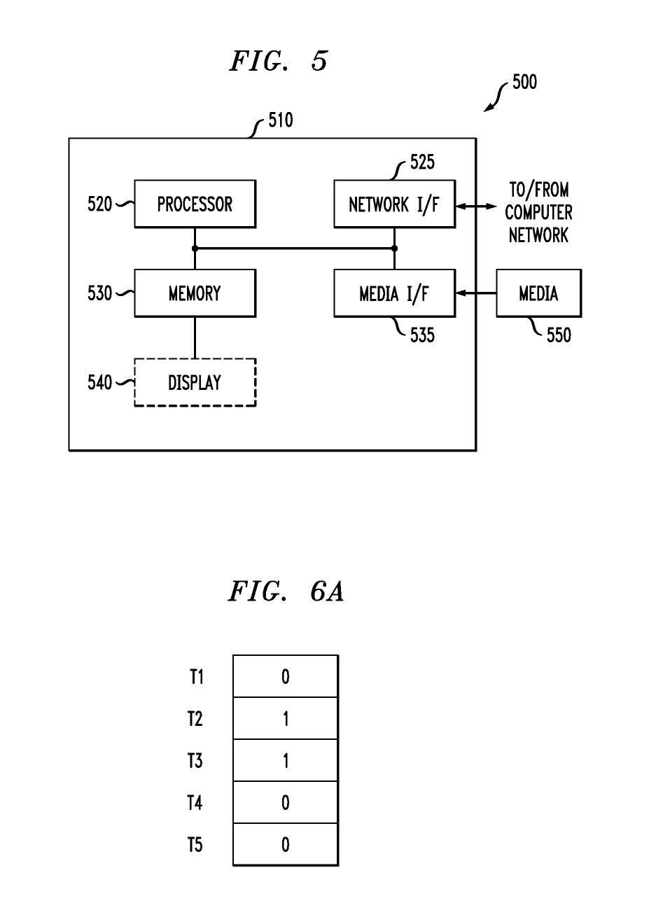

The user mobile devices 402 communicate (i.e., receive instructions, transmit data, etc.) with the provider's system 418 through communications network 414. System 418 may be configured to perform, e.g., the steps of methodology 100 (FIG. 1). An exemplary apparatus that may serve as system 418 is presented in FIG. 5, described below. System 418 is coupled to communications network 414. In one exemplary embodiment, system 418 may be implanted on a computer server. In some embodiments, communications network 414 is a telecommunications network, for example, the public switched telephone network, or in other embodiments it may be a private telephone network. Accordingly, the connection 417 between system 418 and communications network 414 may be a computer telephony interface (CTI) card plugged into system 418. System 418, in some embodiments, may be configured to run an Interactive Voice Response system (IVR), a voice communications system that provides a public telephone switch or a private branch eXchange (PBX). In some embodiments, system 418 may include a software program that responds to signals generated by the IVR. For example, the signals could include ‘incoming call,’ ‘hangup,’ touchtone key press, and any number of other signals. In some embodiments, the software program can record audio originating at the microphone 404 and store this at a location for example, in a file on a computer server and in some embodiments, it can retrieve audio from a location, for example, from a file on a computer server, and play the audio so that it can be heard on the telephone speaker 406. In some embodiments, system 418 may include a web application that runs on a web application server. The web application handles requests and generates responses. The requests may be HTTP requests. The responses may be HTTP responses. The HTTP responses may include an XML document. In some embodiments, the XML document is VoiceXML. In some embodiments, the system 418 may include a VoiceXML browser that interprets VoiceXML and controls the IVR.

System 418 runs an IVR like Asterisk™ or Websphere Voice Server™ that runs a VoiceXML Browser. The VoiceXML Browser generates requests to the Web application server, that run the Java Web application, that carries out the logic detailed in the present techniques. The Java Web application generates Voice XML that is returned and executed on the VoiceXML Browser as part of the IVR.

The system 400 may also include a database 420 coupled to system 418. Database 420 may store information utilized by and/or obtained from system 418. In one embodiment, system 418 may include the database 420 within it. In one exemplary embodiment, database 420 is a MySQL® open source database and contains data obtained by the provider from the users when the users are performing their tasks.

Turning now to FIG. 5, a block diagram is shown of an apparatus 500 for implementing one or more of the methodologies presented herein. As described above, apparatus 500 may serve as the system component of communications system 400, and thus can be configured to implement, for example, one or more of the steps of methodology 100 of FIG. 1 for a provider to generate incentives for users u to perform tasks t.

Apparatus 500 comprises a computer system 510 and removable media 550. Computer system 510 comprises a processor device 520, a network interface 525, a memory 530, a media interface 535 and an optional display 540. Network interface 525 allows computer system 510 to connect to a network, while media interface 535 allows computer system 510 to interact with media, such as a hard drive or removable media 550.

As is known in the art, the methods and apparatus discussed herein may be distributed as an article of manufacture that itself comprises a machine-readable medium containing one or more programs which when executed implement embodiments of the present invention. For instance, when apparatus 500 is configured to implement one or more of the steps of methodology 100 the machine-readable medium may contain a program configured to assign the tasks t to the users u to obtain a matrix of task assignments A(u,t) in which each of the users u is assigned to at least one of the tasks t and each of the tasks t is assigned to at least one of the users u, wherein each of the task assignments in the matrix A(u,t) has a value to the provider and a cost to the provider, wherein for a given one of the task assignments in the matrix A(u,t) the value to the provider less the cost to the provider is an economic utility to the provider, and wherein the step of assigning the tasks to the users is done so as to maximize a net benefit to the provider which is a sum of the economic utility to the provider for all of the task assignments in the matrix A(u,t); and offer incentives to the users u to perform the task assignments.

The machine-readable medium may be a recordable medium (e.g., floppy disks, hard drive, optical disks such as removable media 550, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used.

Processor device 520 can be configured to implement the methods, steps, and functions disclosed herein. The memory 530 could be distributed or local and the processor device 520 could be distributed or singular. The memory 530 could be implemented as an electrical, magnetic or optical memory, or any combination of these or other types of storage devices. Moreover, the term “memory” should be construed broadly enough to encompass any information able to be read from, or written to, an address in the addressable space accessed by processor device 520. With this definition, information on a network, accessible through network interface 525, is still within memory 530 because the processor device 520 can retrieve the information from the network. It should be noted that each distributed processor that makes up processor device 520 generally contains its own addressable memory space. It should also be noted that some or all of computer system 510 can be incorporated into an application-specific or general-use integrated circuit.

Optional video display 540 is any type of video display suitable for interacting with a human user of apparatus 500. Generally, video display 540 is a computer monitor or other similar video display.

The present techniques are further described by way of reference to the following non-limiting examples.

### Example 1

### Reduce Malaria

The United Nations (U.N.) would like to reduce malaria by draining standing water in Uganda. They do not know where the standing water is or how large it is, and do not have enough manpower to go out and catalog it. The U.N. knows the distribution of existing malaria. They can identify which regions are more valuable to drain. They can also estimate the cost to travel to these regions.

Solution: Provide an incentive for Ugandans to find the standing water that covers the most travel costs while providing additional incentive for areas of most value due to high existing malaria. The U.N. advertises: text *123 to 555-UNUN so that you can register as a helper to save Uganda from malaria.

Each user receives an assignment to catalog the standing water in a given region. This includes a monetary incentive to complete the cataloging. When a user finds some standing water, the user: 1) types in (into his/her mobile device) the name of the body or water or nearby landmark if known, 2) takes a picture of the standing water and 3) launches an application on his/her mobile device that sends an SMS (name and global positioning system (GPS) location) and MMS (picture) to the U.N. server. Later, someone at the U.N. checks the information and approves it. The user receives the reward or is sent a message to retry.

### Example 2

### Giving Blood

A blood bank would like to collect blood because the supply is getting dangerously low. They have run out of volunteers.

The blood bank has a target for each blood type A, B, AB and O. O blood is worth the most to the blood bank because it is the universal donor, AB the next most since it is rare, and A and B last. The blood bank can estimate the cost for people to travel to the nearest donation center based, for example, on a database of donation center locations and the location of the user's cell phone while they are using the service.

Problem: How does the blood bank get people to travel to the nearest center and donate blood? How do they incentivize people so that they get the blood types they need?

Solution: Provide an incentive for people to donate that covers the most travel costs while providing additional incentives for the needed blood types. For example, the blood bank advertises: text *456 to 555-GIVE to register to give blood. Each user/helper receives an assignment to give blood at a given donation center. It explains you will be paid a certain amount upon successful completion.

The helper confirms they will donate. After donating they are given a special code from the people who take their blood. They text the code to 555-GIVE. The code is verified. The user receives the amount on their mobile phone bill as a reward.

### Example 3

### DVD Rental

The broadcaster (provider) wants feedback/responses from users near age 15 because early teens are the target demographic for the broadcaster. In this case, the task is for the teen (user) to send an SMS back to the broadcaster with his/her ratings of DVD movies they have recently returned to the rental store. The broadcaster does not have the user's age, but he has other information correlated with the user's age, such as his/her DVD rental record. The present techniques could use a distance metric mapping attributes of DVD rental records (e.g., frequency weighted by genre) to age. The distance metric could be provided or computed from historical data. Methodology 100 (described above) could then broadcast incentives to users with mobile phones based on this distance metric (i.e., distance from age 15). If the incentive was below a threshold, the message might not be sent.

The user's expected cost in performing the task can also be based on a metric. For example, the broadcaster may have the mobile phone records of the users. A metric may be: the effort required is inversely proportion to the number of text messages sent per month, figuring that more active users will be more likely to respond using text messaging. The cost could be quantified in terms of the value of time and the amount of time for users at various levels of frequency of texting to complete the DVD rental record response. Determining costs can be difficult when activities involved in a task are not associated with a monetary value. In this case, a metric can be used. For example, users could be divided into 3 groups: non-users, infrequent users, and frequent users. A cost could then be associated with each of these groups. The users could then be categorized into one of the groups.

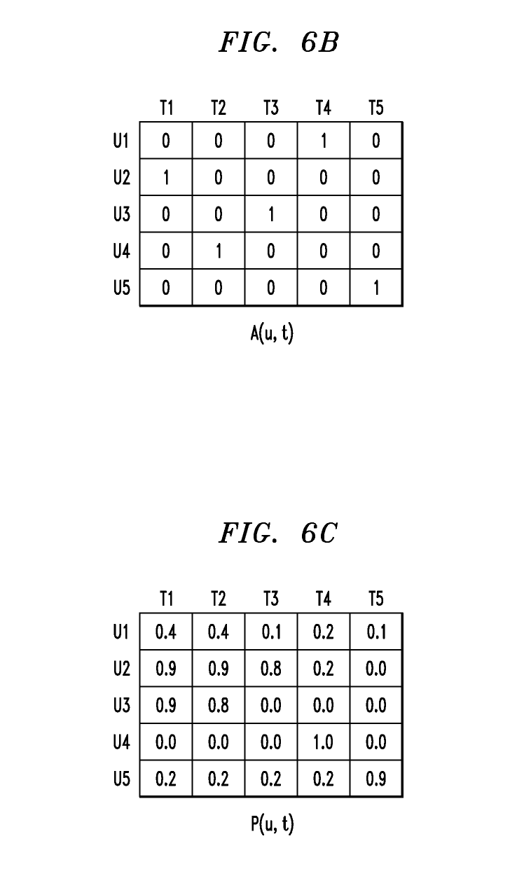

FIGS. 6A-C are exemplary tables. The table in FIG. 6A is an exemplary table for matrix D(t). D(1)=0, D(2)=1, D(3)=1, D(4)=0, and D(5)=0, starting from top to bottom. D(1)=0 indicates that the first task (T1) is not complete, D(2)=1 indicates that the second task (T2) is complete, and so on.

The table in FIG. 6B is an exemplary table for matrix A(u, t). A(1,1)=0, A(1, 2)=0, A(1, 3)=0, A(1, 4)=1, A(1, 5)=0. This row indicates that the first user (U1) is assigned to task 4 (T4). A(2, 1)=1 indicates that the second user (U2) is assigned to task 1 (T1). Every user is assigned to one and only one task and every task is assigned to one and only one user.

The table in FIG. 6C is an exemplary table for matrix P(u, t). P(1,1)=0.4, P(1, 2)=0.4, P(1, 3)=0.1, and so on. This indicates that the probability of the first user (U1) completing the first task (T1) is 40% (0.4). U1 has the same probability of completing the second task (T2). However, U1 has only a 10% (0.1) probability of completing the third task (T3). Note that the probabilities do not have to add up to 100%. Some users may have a high probability of completing all tasks. Similarly, some tasks may have a low probability of being completed by each user.

Matrix V(u,t) (not shown) has the same dimensions as P(u,t), but its values are decimals corresponding to dollar amounts (for example, 4.52 or 1.67). Similarly, matrix C(u,t) (not shown) has the same dimensions as P(u,t) but its values are decimals corresponding to dollar amounts for costs (for example, 2.50 or 5.25). Matrix U(u, t) (not shown) has the same dimensions as P(u,t) but its values are decimals corresponding to fractional dollar amounts (for example, 4.1 or 6.3467). This unit, (fractional dollar amounts), is due to it being a product of a probability and a dollar amount.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method for a provider to generate incentives for users u to perform tasks t, the method comprising the steps of:
assigning the tasks t to the users u to obtain a matrix of task assignments A(u,t) in which each of the users u is assigned to at least one of the tasks t and each of the tasks t is assigned to at least one of the users u, wherein each of the task assignments in the matrix A(u,t) has a value to the provider and a cost to the provider, wherein for a given one of the task assignments in the matrix A(u,t) the value to the provider less the cost to the provider is an economic utility to the provider, and wherein the step of assigning the tasks to the users is done so as to maximize a net benefit to the provider which is a sum of the economic utility to the provider for all of the task assignments in the matrix A(u,t); and
offering incentives to the users u to perform the task assignments in the matrix A(u,t).

2. The method of claim 1, further comprising the step of:
representing the value to the provider for each of the task assignments as a matrix V(u,t) of values, wherein the values in the matrix V(u,t) are a function of a probability that user u performs task t.

3. The method of claim 2, further comprising the step of:
representing the incentives offered to the users u to perform the task assignments as a matrix I(u,t) of values, wherein the values in the matrix I(u,t) are based on the economic utility of the task assignments to the provider.

4. The method of claim 2, further comprising the step of:
representing the probability that user u performs task t for each of the task assignments as a matrix P(u,t) of values.

5. The method of claim 3, wherein there are costs to the users u to perform the task assignments, the method further comprising the step of:
representing the costs to the users as a matrix C(u,t) of values.

6. The method of claim 5, wherein the values in the matrix I(u,t) are based on the costs to the users u to perform the task assignments.

7. The method of claim 5, wherein the values in the matrix I(u,t) include the costs to the users u to perform the task assignments.

8. The method of claim 7, wherein the values in the matrix I(u,t) include a portion of a budget divided equally among the users.

9. The method of claim 1, wherein the cost to the provider for a given one of the task assignments in which a given one of the users u is assigned to a given one of the tasks t includes an amount equal to the incentive offered to the user u to perform the task t.

10. The method of claim 1, further comprising the step of:
representing the economic utility to the provider for all of the task assignments as a matrix U(u,t) of values,

11. The method of claim 10, further comprising the steps of:
determining from the matrix U(u,t), for each of the task assignments, whether the economic utility to the provider is positive; and
offering the incentive for the task assignments for which the economic utility is positive.

12. The method of claim 5, wherein the incentive offered to a given one of the users u to perform a given one of the tasks t includes a portion of a budget equal to the cost to the user u to perform the task t divided by a sum of a total cost of the users to perform the tasks assigned to the users.

13. The method of claim 1, further comprising the step of:
rewarding the users u upon completion of the tasks t assigned to the users u.

14. The method of claim 1, wherein the users u comprise mobile users.

15. The method of claim 1, wherein the incentive comprises a monetary incentive.

16. The method of claim 1, wherein the incentive comprises a non-monetary incentive.

17. The method of claim 1, further comprising the step of:
broadcasting to the users u, messages describing the tasks t assigned to the users u and the incentive.

18. The method of claim 17, wherein the messages contain a deadline for completing each of the tasks t.

19. The method of claim 1, further comprising the step of:
imposing one or more of spatial, temporal and spatio-temporal constraints on the tasks t.

20. The method of claim 1, further comprising the step of:
repeating the assigning and offering steps wherein one or more of the users u have changed.

21. The method of claim 1, further comprising the step of:
repeating the assigning and offering steps wherein one or more of the tasks t have changed.

22. An apparatus for a provider to generate incentives for users u to perform tasks t, the apparatus comprising:
a memory; and
at least one processor device, coupled to the memory, operative to:
assign the tasks t to the users u to obtain a matrix of task assignments A(u,t) in which each of the users u is assigned to at least one of the tasks t and each of the tasks t is assigned to at least one of the users u, wherein each of the task assignments in the matrix A(u,t) has a value to the provider and a cost to the provider, wherein for a given one of the task assignments in the matrix A(u,t) the value to the provider less the cost to the provider is an economic utility to the provider, and wherein the step of assigning the tasks to the users is done so as to maximize a net benefit to the provider which is a sum of the economic utility to the provider for all of the task assignments in the matrix A(u,t); and
offer incentives to the users u to perform the task assignments.

23. An article of manufacture for a provider to generate incentives for users u to perform tasks t, comprising a machine-readable recordable medium containing one or more programs which when executed implement the steps of:
assigning the tasks t to the users u to obtain a matrix of task assignments A(u,t) in which each of the users u is assigned to at least one of the tasks t and each of the tasks t is assigned to at least one of the users u, wherein each of the task assignments in the matrix A(u,t) has a value to the provider and a cost to the provider, wherein for a given one of the task assignments in the matrix A(u,t) the value to the provider less the cost to the provider is an economic utility to the provider, and wherein the step of assigning the tasks to the users is done so as to maximize a net benefit to the provider which is a sum of the economic utility to the provider for all of the task assignments in the matrix A(u,t); and
offering incentives to the users u to perform the task assignments.
